(19) United States
(12) Patent Application Publication
(10) Pub. No.: US 2019/0310804 A1
(43) Pub. Date: Oct. 10, 2019

(54) TERMINAL APPARATUS AND IMAGE FORMING SYSTEM

(71) Applicant: Oki Data Corporation, Tokyo (JP)

(72) Inventor: Takafumi FUKUDA, Tokyo (JP)

(73) Assignee: Oki Data Corporation, Tokyo (JP)

(21) Appl. No.: 16/367,521

(22) Filed: Mar. 28, 2019

(30) Foreign Application Priority Data
Apr. 10, 2018 (JP) 2018-075467

(51) Int. Cl. G06F 3/12; G06F 11/07; G03G 15/00

(52) U.S. Cl. CPC G06F 3/121; G06F 11/0766; G03G 15/5016; G06F 11/0733; G06F 3/1286

(57) ABSTRACT

A terminal apparatus includes: an acquiring circuitry, a generator, a communicator, and a display. The acquiring circuitry acquires, from an image forming apparatus having a trouble, apparatus information related to the image forming apparatus and notification information corresponding to the trouble. The generator generates search instruction information on the basis of the apparatus information and the notification information both acquired by the acquiring circuitry. The search instruction information includes a search keyword to be used in a search server. The communicator acquires a search result related to the trouble by accessing the search server with use of the search instruction information. The display displays the search result.

### CROSS REFERENCE TO RELATED APPLICATIONS

The present application claims priority from Japanese Patent Application No. 2018-075467 filed on Apr. 10, 2018, the entire contents of which are hereby incorporated by reference.

### BACKGROUND

The technology relates to a terminal apparatus that is able to exchange information between the terminal apparatus and an image forming apparatus, and to an image forming system provided with the terminal apparatus.

An image forming apparatus can have various types of troubles. Japanese Unexamined Patent Application Publication No. 2010-176365 discloses a trouble solving assist system that displays a solution to a trouble that has already occurred in the past in an image forming apparatus.

### SUMMARY

It is desired to provide an image forming apparatus with high friendliness to a user of the image forming apparatus and high friendliness to a vendor of the image forming apparatus. Further, it is expected to improve the friendliness to the user of the image forming apparatus and the friendliness to the vendor of the image forming apparatus.

It is desirable to provide a terminal apparatus and an image forming system that each increase user friendliness, vendor friendliness, or both.

According to one embodiment of the technology, there is provided a terminal apparatus that includes an acquiring circuitry, a generator, a communicator, and a display. The acquiring circuitry acquires, from an image forming apparatus having a trouble, apparatus information related to the image forming apparatus and notification information corresponding to the trouble. The generator generates search instruction information on the basis of the apparatus information and the notification information both acquired by the acquiring circuitry. The search instruction information includes a search keyword to be used in a search server. The communicator acquires a search result related to the trouble by accessing the search server with use of the search instruction information. The display displays the search result.

According to one embodiment of the technology, there is provided an image forming system that includes an image forming apparatus, a search server, and a terminal apparatus. The image forming apparatus forms an image on a print medium. The search server provides content information based on a search keyword by performing a search process. The terminal apparatus includes an acquiring circuitry, a generator, a communicator, and a display. The acquiring circuitry acquires from the image forming apparatus, when the image forming apparatus is having a trouble, apparatus information related to the image forming apparatus and notification information corresponding to the trouble. The generator generates search instruction information on the basis of the apparatus information and the notification information both acquired by the acquiring circuitry. The search instruction information includes the search keyword. The communicator acquires a search result related to the trouble by accessing the search server with use of the search instruction information. The display displays the search result.

### BRIEF DESCRIPTION OF DRAWINGS

FIG. 1 is a block diagram illustrating an example of a configuration of an image forming system according to one embodiment of the technology.

FIG. 2 is a block diagram illustrating an example of a configuration of hardware of an image forming apparatus illustrated in FIG. 1.

FIG. 3 is a diagram illustrating an example of a configuration of an operation panel illustrated in FIG. 2.

FIG. 4 is a block diagram illustrating an example of a configuration of software of the image forming apparatus illustrated in FIG. 1.

FIG. 5 is an explanatory diagram illustrating an example of a configuration of an error information table illustrated in FIG. 4.

FIG. 6 is an explanatory diagram illustrating an example of a configuration of a help information table illustrated in FIG. 4.

FIG. 7 is an explanatory diagram illustrating an example of a configuration of tag information.

FIG. 8 is a block diagram illustrating an example of a configuration of hardware of a mobile terminal illustrated in FIG. 1.

FIG. 9 is a block diagram illustrating an example of a configuration of software of the mobile terminal illustrated in FIG. 1.

FIG. 10 is a block diagram illustrating an example of a configuration of hardware of an FAQ content server illustrated in FIG. 1.

FIG. 11 is a block diagram illustrating an example of a configuration of software of the FAQ content server illustrated in FIG. 1.

FIG. 12 is a flowchart illustrating an example of operation of the image forming apparatus illustrated in FIG. 1.

FIG. 13A is an explanatory diagram illustrating an example of an error message.

FIG. 13B is an explanatory diagram illustrating another example of the error message.

FIG. 14A is an explanatory diagram illustrating an example of a help message.

FIG. 14B is an explanatory diagram illustrating another example of the help message.

FIG. 15 is a flowchart illustrating an example of operation of the mobile terminal illustrated in FIG. 1.

FIG. 16 is an explanatory diagram illustrating an example of a WEB page generated by a WEB server section illustrated in FIG. 11.

FIG. 17 is an explanatory diagram illustrating another example of the WEB page generated by the WEB server section illustrated in FIG. 11.

FIG. 18 is an explanatory diagram illustrating still another example of the WEB page generated by the WEB server section illustrated in FIG. 11.

FIG. 19 is an explanatory diagram illustrating an example of a content page.

FIG. 20 is an explanatory diagram illustrating an example of page data of a content page illustrated in FIG. 19.

FIG. 21 is an explanatory diagram illustrating an example of a configuration of tag information according to a modification example.

FIG. 22 is a block diagram illustrating an example of a configuration of software of a mobile terminal according to the modification example.

FIG. 23 is an explanatory diagram illustrating an example of a keyword table illustrated in FIG. 22.

### DETAILED DESCRIPTION

Hereinafter, some example embodiments of the technology will be described in detail with reference to the drawings. Note that the following description is directed to illustrative examples of the technology and not to be construed as limiting to the technology. Factors including, without limitation, numerical values, shapes, materials, components, positions of the components, and how the components are coupled to each other are illustrative only and not to be construed as limiting to the technology. Further, elements in the following example embodiments which are not recited in a most-generic independent claim of the technology are optional and may be provided on an as-needed basis. The drawings are schematic and are not intended to be drawn to scale. Note that the like elements are denoted with the same reference numerals, and any redundant description thereof will not be described in detail.

### EXAMPLE EMBODIMENT

### Configuration Example

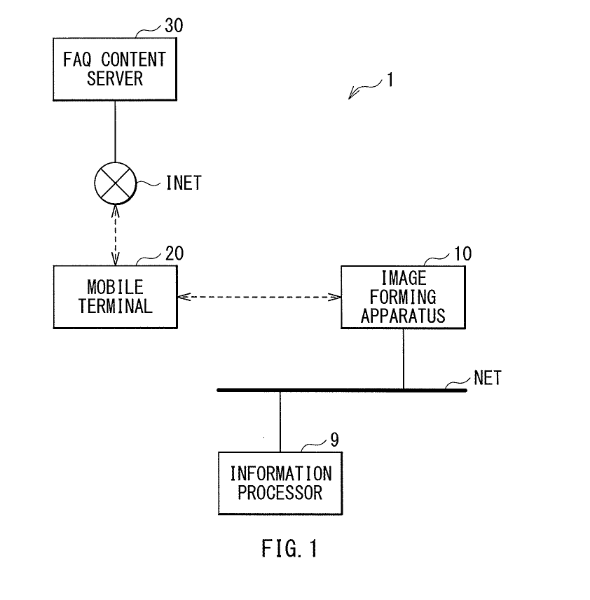

FIG. 1 illustrates an example of a configuration of an image forming system 1, i.e., an image forming system provided with a terminal apparatus according to an example embodiment of the technology. The image forming system 1 may include an image forming apparatus 10, an information processor 9, a mobile terminal 20, and a frequently asked questions (FAQ) content server 30.

The image forming apparatus 10 may be a so-called printer that forms an image on a print medium. Non-limiting examples of the print medium may include paper and any other printable medium. The image forming apparatus 10 may be coupled to a network NET. The network NET may include, for example but not limited to, a wired local area network (LAN). The image forming apparatus 10 may form an image on the print medium on the basis of print data DP supplied from the information processor 9 via the network NET. The image forming apparatus 10 may also perform near field communication (NFC) between the image forming apparatus 10 and the mobile terminal 20.

Although the network NET may include the wired LAN in this example, this is non-limiting. In an alternative example, the network may include a wireless LAN. Further, although the coupling between the image forming apparatus 10 and the information processor 9 may be achieved by means of the use of the network NET in this example, this is non-limiting. In an alternative example, the image forming apparatus 10 may be coupled to the information processor 9 directly by means of a universal serial bus (USB).

The information processor 9 may be, for example but not limited to, a personal computer. The information processor 9 may be coupled to the network NET. For example, a user may be able to create a document by operating the information processor 9. Further, in response to the user's giving an instruction to print the created document, the information processor 9 may generate the print data DP on the basis of the document and supply the generated print data DP to the image forming apparatus 10 via the network NET.

The mobile terminal 20 may be a portable terminal apparatus. In one example, the mobile terminal 20 may be a so-called smartphone; however, this is non-limiting. In an alternative example, the mobile terminal 20 may be any other portable terminal apparatus such as a tablet terminal or a laptop personal computer. The mobile terminal 20 may perform NFC between the mobile terminal 20 and the image forming apparatus 10. The mobile terminal 20 may also be coupled to the Internet INET by so-called mobile communication between the mobile terminal 20 and an unillustrated mobile phone base station. The mobile communication between the mobile terminal 20 and the unillustrated mobile phone base station may be achieved by means of, for example but not limited to, long term evolution (LTE), 3rd generation (3G), or any other communication technology. The way of coupling between the mobile terminal 20 and the Internet INET is not limited to that described above. In an alternative example, the mobile terminal 20 may be coupled to the Internet INET by means of a public wireless LAN, an intranet wireless LAN, or any other communication technology.

The FAQ content server 30 may provide content indicating an answer to a frequently-asked question (FAQ) related to the image forming apparatus 10. For example, the FAQ content server 30 may include a database including a plurality of pieces of page data of content pages. The FAQ content server 30 may perform a search process by means of the database on the basis of a search keyword KW and thereby provide a content page associated with the search keyword KW. The FAQ content server 30 may be managed, for example but not limited to, by a vendor of the image forming apparatus 10. The FAQ content server 30 may be coupled to the Internet INET.

The above-described configuration may allow the image forming system 1 to operate as follows. For example, on a condition that an error occurs in the image forming apparatus 10 and the user operates a help button 15E of the image forming apparatus 10, the image forming apparatus 10 may cause a help message to be displayed on an operation panel. The help button 15E will be described later. Further, the image forming apparatus 10 may prepare a search keyword KW corresponding to the error. Further, in response to the user's placing the mobile terminal 20 over the image forming apparatus 10, the mobile terminal 20 may acquire the search keyword KW from the image forming apparatus 10 by means of the NFC and generate a uniform resource identifier (URI) that includes the acquired search keyword KW. Further, the mobile terminal 20 may access the FAQ content server 30 via the Internet INET with the use of the generated URI. The FAQ content server 30 may perform a search process on the basis of the search keyword KW included in the URI. The FAQ content server 30 may thereby identify a content page associated with the search keyword KW. Further, the FAQ content server 30 may supply the mobile terminal 20 with page data of the identified content page. In this example, the content page may include guidance information directed to solving the error that has occurred in the image forming apparatus 10. Further, the mobile terminal 20 may display the content page. Thus, the user may be able to know how to solve the error that has occurred in the image forming apparatus 10 by browsing the displayed content page.

### Image Forming Apparatus 10

FIG. 2 illustrates an example of a configuration of hardware of the image forming apparatus 10. The image forming apparatus 10 may include a central processing unit (CPU) 11, a read-only memory (ROM) 12, a random-access memory (RAM) 13, a storage device 14, an operation panel 15, a network communication section 16, an NFC tag 17, and an image forming section 18. The CPU 11, the ROM 12, the RAM 13, the storage device 14, the operation panel 15, the network communication section 16, the NFC tag 17, and the image forming section 18 may be coupled to each other via an internal bus 19.

The CPU 11 may execute various programs that control various types of operation including, for example but not limited to, communication operation, image forming operation, and operation of notification for the user. The ROM 12 may hold the various programs described above. The RAM 13 may temporarily hold data to be used when the CPU 11 executes any of the various programs.

The storage device 14 may be a non-volatile storage device that holds information such as apparatus information related to the image forming apparatus 10 or various types of setting information related to the image forming apparatus 10. For example, the storage device 14 may hold model name information IM, language setting information IL, and an application software identifier SID. The model name information IM may be related to a model name of the image forming apparatus 10. In this example, the model name of the image forming apparatus 10 may be “Model01”. The language setting information IL may be related to a language setting of the image forming apparatus 10. In one non-limiting example, the language setting information IL may be set to one of “ja” and “en”. In an example case where the language setting information IL is “ja”, the language to be used in the image forming apparatus 10 may be set to Japanese. In accordance therewith, for example, a display section of the operation panel 15 may display a Japanese message. In another example case where the language setting information IL is “en”, the language to be used in the image forming apparatus 10 may be set to English. The application software identifier SID may be a unique identifier associated with guidance application software 205 to be installed on the mobile terminal 20. The guidance application software 205 will be described later. The storage device 14 may also hold an error information table 106A and a help information table 106B both of which will be described later.

The operation panel 15 may display information such as an operation state of the image forming apparatus 10 or a notification message directed to the user. The operation panel 15 may also receive the operation performed by the user.

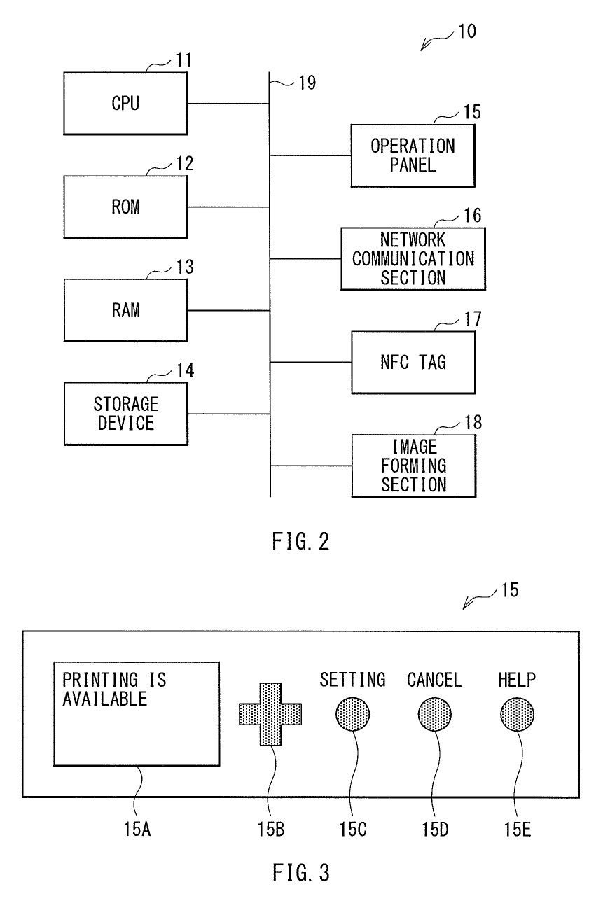

FIG. 3 illustrates an example of a configuration of the operation panel 15. The operation panel 15 may include a display section 15A, a cursor key 15B, a setting button 15C, a cancel button 15D, and a help button 15E. The display section 15A may display information such as a setting menu or various messages. The display section 15A may include, for example but not limited to, a liquid crystal display. The display section 15A may include a small display screen. The small display screen may be able to display, for example but not limited to, a character string of about several rows. The cursor key 15B may be operated by the user when the user wants to move a cursor displayed on the display section 15A. The setting button 15C may be operated by the user when the user wants to decide execution of a process on the basis of an instruction displayed on the display section 15A. The cancel button 15D may be operated by the user when the user wants to cancel execution of a process on the basis of an instruction displayed on the display section 15A. The help button 15E may be operated by the user when the user wants to cause the display section 15A to display a help message including information directed to solving an error indicated in an error message displayed on the display section 15A.

The network communication section 16 may be a network interface card (NIC) that performs communication via the network NET. In this example, the network communication section 16 may receive the print data DP supplied from the information processor 9 via the network NET.

The NFC tag 17 may be an integrated circuit (IC) tag that includes a communicator and a non-volatile memory. The communicator may perform NFC. The NFC tag 17 may hold tag information INF. In response to the user's placing the mobile terminal 20 over the image forming apparatus 10, the NFC tag 17 may allow the tag information INF to be read by the mobile terminal 20.

The image forming section 18 may form an image on the print medium with the use of a black toner, a cyan toner, a magenta toner, and a yellow toner. The image forming section 18 may include four toner cartridges, four image drum (ID) units, a transfer section, and a fixing section. Each of the four toner cartridges may contain corresponding one of the toner of the four colors, i.e., the black toner, the cyan toner, the magenta toner, and the yellow toner. Each of the four ID units may form a toner image with the use of corresponding one of the toners of the four colors contained in the respective four toner cartridges. The transfer section may transfer the toner images formed by the respective four ID units onto the print medium taken out from a cassette. The fixing section may fix, to the print medium, the toner image transferred onto the print medium. The image forming section 18 may discharge, to a discharge tray, the print medium to which the toner image has been fixed. The image forming section 18 may be provided with, for example but not limited to, a both-side printing section set to the image forming section 18. Thereby, the image forming section 18 may be able to form images on both sides of the print medium.

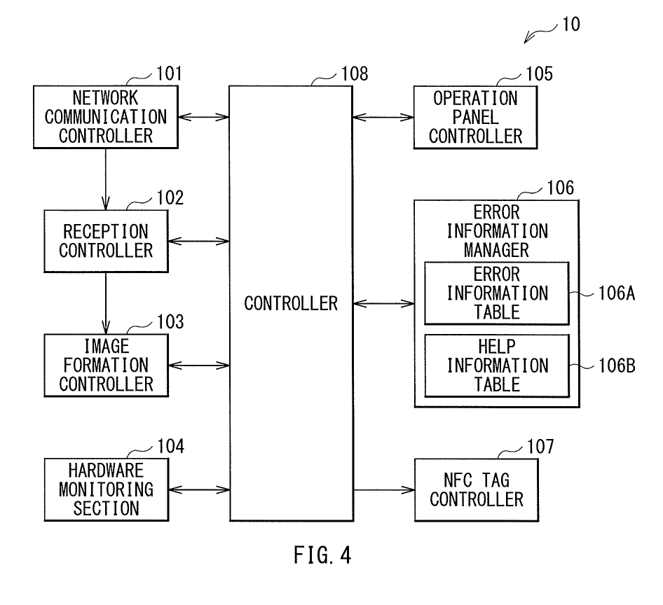

FIG. 4 illustrates an example of a configuration of software to be executed by the image forming apparatus 10. The image forming apparatus 10 may include a network communication controller 101, a reception controller 102, an image formation controller 103, a hardware monitoring section 104, an operation panel controller 105, an error information manager 106, an NFC tag controller 107, and a controller 108.

The network communication controller 101 may control operation of the network communication section 16 and thereby cause the network communication section 16 to perform communication between the network communication section 16 and the information processor 9 via the network NET. In a case where an error occurs in the communication by means of the network communication section 16, the network communication controller 101 may notify the controller 108 of an error identifier EID associated with the error.

The reception controller 102 may cause the network communication section 16 to receive the print data DP. The reception controller 102 may also handover the print data DP from the network communication controller 101 to the image formation controller 103. In a case where an error occurs in operation of receiving the print data DP, the reception controller 102 may notify the controller 108 of the error identifier EID associated with the error.

The image formation controller 103 may perform a predetermined image process on the basis of the print data DP. The image formation controller 103 may also cause the image forming section 18 to form an image by controlling operation of the image forming section 18 on the basis of the image data that has been subjected to the image process. In a case where an error occurs in the image process performed by the image formation controller 103, in the image formation operation performed by the image forming section 18, or in any other process or operation, the image formation controller 103 may notify the controller 108 of the error identifier EID associated with the error.

In one example, the hardware monitoring section 104 may perform monitoring of a state of the hardware of the image forming apparatus 10. In another example, the hardware monitoring section 104 may constantly perform monitoring of a state of the hardware of the image forming apparatus 10. In a case where an error occurs in operation of the hardware, the hardware monitoring section 104 may notify the controller 108 of the error identifier EID associated with the error.

The operation panel controller 105 may control operation of the operation panel 15 on the basis of an instruction given by the controller 108. The operation panel controller 105 may thereby cause the display section 15A of the operation panel 15 to display information, or may thereby receive operation performed by the user on any of the cursor key 15B, the setting button 15C, the cancel button 15D, and the help button 15E.

The error information manager 106 may manage an error message and a help message that are to be displayed on the display section 15A of the operation panel 15 when an error occurs in the image forming apparatus 10. The error information manager 106 may manage the error information table 106A and the help information table 106B. The error information table 106A may be referred to when an error occurs in the image forming apparatus 10. The help information table 106B may be referred to on a condition that the display section 15A of the operation panel 15 displays an error message and the user operates the help button 15E of the operation panel 15. The error information table 106A and the help information table 106B may be stored in the storage device 14 illustrated in FIG. 2.

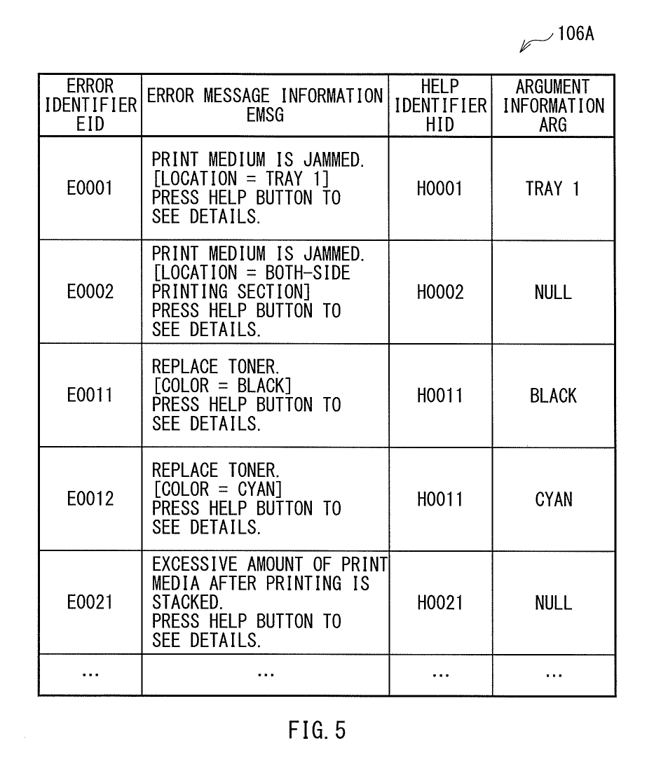

FIG. 5 illustrates an example of a configuration of the error information table 106A. “NULL” described in FIG. 5 may indicate that no information is set. The error information table 106A may hold the error identifier EID, error message information EMSG, a help identifier HID, and argument information ARG that are related to each other.

The error identifier EID may be a unique identifier associated with an error that may possibly occur in the image forming apparatus 10.

The error message information EMSG may be related to an error message to be displayed on the operation panel 15.

The help identifier HID may be a unique identifier related to a help message to be displayed on the operation panel 15 on a condition that the display section 15A of the operation panel 15 displays an error message and the user operates the help button 15E of the operation panel 15.

The argument information ARG may indicate a phrase to be used in the help message to be displayed on the operation panel 15 on the condition described above. The argument information ARG may be used as an argument upon generation of the help message to be displayed. The argument information ARG may not be set in some cases, as illustrated in FIG. 5. In this example, the argument information ARG may not be set for an error that the print medium is jammed in a both-side printing section, i.e., a case where the error identifier EID is “E0002”. In this example, the argument information ARG may not be set also for an error that an excessive amount of the print media after printing is stacked in the discharge tray, i.e., a case where the error identifier EID is “E0021”.

The above-described configuration may allow, when an error occurs in the image forming apparatus 10, the error information manager 106 to identify the error message information EMSG, the help identifier HID, and the argument information ARG that are related to the error identifier EID, on the basis of the error identifier EID, by means of the error information table 106A. The error identifier EID may be supplied from the controller 108. Thereby, the display section 15A of the operation panel 15 may display an error message on the basis of the identified error message information EMSG.

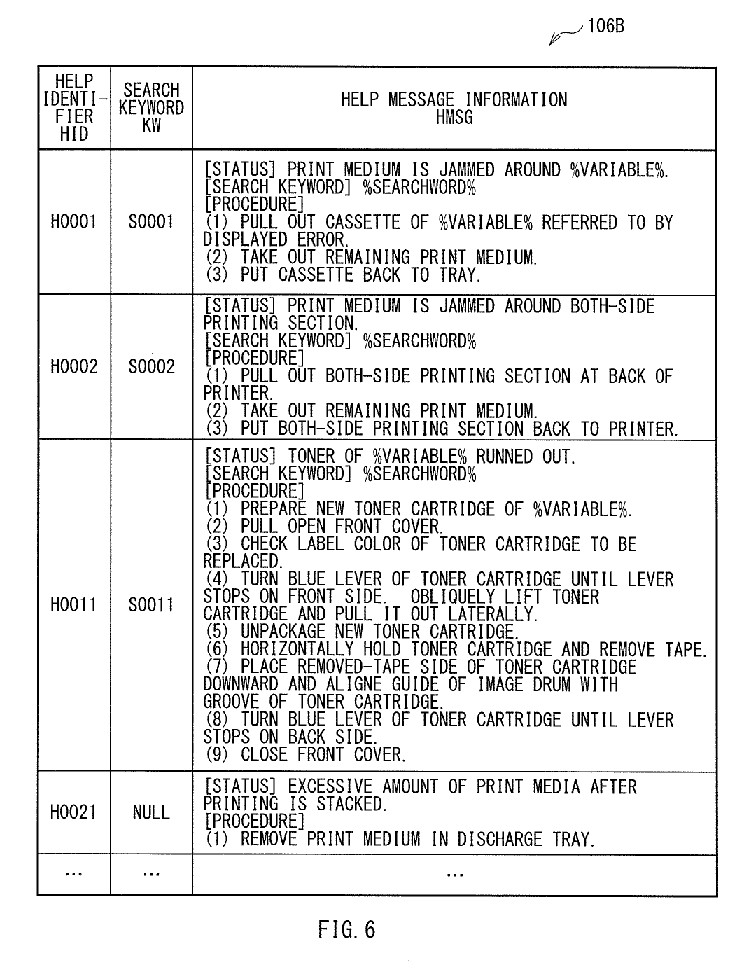

FIG. 6 illustrates an example of a configuration of the help information table 106B. “NULL” described in FIG. 6 may indicate that no information is set. The help information table 106B may hold the help identifier HID, the search keyword KW, and help message information HMSG that are related to each other.

The search keyword KW may be used when the FAQ content server 30 performs the search process. In this example, the search keyword KW may be, for example but not limited to, an identification code that includes a character such as an alphabet or a number and has no specific meaning, in this example. Non-limiting examples of the search keyword KW as that described above may include “S0001”.

The help message information HMSG may be related to a help message to be displayed on the display section 15A when the user operates the help button 15E of the operation panel 15. The help message information HMSG may include information related to a status of an error, information related to the search keyword KW, and information related to a method of solving an error that are referred to as a “status”, a “search keyword”, and a “procedure”, respectively. The help message information HMSG may include two variables, i.e., “VARIABLE” and “SEARCHWORD”, in this example. The two variables may be disposed between “%” and “%” when being used. When the help message is displayed, a “% VARIABLE %” part included in the help message information HMSG may be replaced with a character string indicated by the argument information ARG in the error information table 106A. Further, when the help message is displayed, a “% SEARCHWORD %” part included in the help message information HMSG may be replaced with a character string indicated by the search keyword KW.

The search keyword KW may not be set in some cases, as illustrated in FIG. 6. For example, the search keyword KW may not be set for an error that an excessive amount of the print media after printing is stacked in the discharge tray, i.e., the case where the error identifier EID is “E0021” and the help identifier HID is “H0021”. In a case where the error occurs that the excessive amount of the print media after printing is stacked in the discharge tray, the reason of the error may be clear. Therefore, the user can easily solve the error without looking into information related to the FAQ. Accordingly, it is unlikely that the FAQ content server 30 is accessed in this example. Hence, the search keyword KW may not be set in this example.

The above-described configuration may allow, when the user operates the help button 15E of the operation panel 15, the error information manager 106 to identify the search keyword KW and the help message information HMSG that are related to the help identifier HID. The error information manager 106 may perform the above-described identification of the search keyword KW and the help message information HMSG, by means of the help information table 106B, on the basis of the help identifier HID and the argument information ARG that have been identified by means of the error information table 106A. Further, the error information manager 106 may generate the help message to be displayed, on the basis of the help message information HMSG, the argument information ARG, and the search keyword KW.

For example, in the error information table 106A illustrated in FIG. 5, the error that the print medium is jammed in “Tray 1”, i.e., a case where the error identifier EID is “E0001”, may be associated with the help identifier HID indicating “H001” and the argument information ARG indicating the “Tray 1”. On a condition that the display section 15A of the operation panel 15 displays an error message indicating that the print medium is jammed in “Tray 1” and the user operates the help button 15E of the operation panel 15, the error information manager 106 may identify the help message information HMSG related to the help identifier HID indicating “H0001” in the help information table 106B illustrated in FIG. 6. The help identifier HID indicating “H0001” may be related to the search keyword KW indicating “S0001”. Accordingly, the error information manager 106 may replace the “% VARIABLE %” part included in the help message information HMSG with “Tray 1” of the argument information ARG The error information manager 106 may also replace the “% SEARCHWORD %” part included in the help message information HMSG with “S0001” of the search keyword KW. The error information manager 106 may thereby generate the help message to be displayed. Further, the display section 15A of the operation panel 15 may display the help message generated by the error information manager 106.

The NFC tag controller 107 may write the tag information INF on the NFC tag 17 in an NFC data exchange format (NDEF) on the basis of an instruction given from the controller 108.

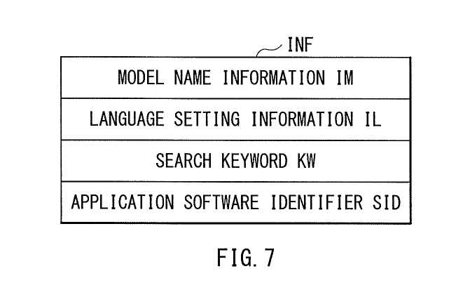

FIG. 7 illustrates an example of the tag information INF. In this example, the tag information INF may include the model name information IM, the language setting information IL, the search keyword KW, and the application software identifier SID.

The NFC tag controller 107 may write the tag information INF on the NFC tag 17, for example but not limited to, when the image forming apparatus 10 is turned on. In this case, a record related to the search keyword KW of the tag information INF may be blank. In other words, the tag information INF may not include the search keyword KW in this case. Further, for example, on a condition that the user operates the help button 15E of the operation panel 15 and the error information manager 106 acquires the search keyword KW other than “NULL”, the NFC tag controller 107 may write the tag information INF including the acquired search keyword KW on the NFC tag 17.

The controller 108 may control operation of each of the network communication controller 101, the reception controller 102, the image formation controller 103, the hardware monitoring section 104, the operation panel controller 105, the error information manager 106, and the NFC tag controller 107.

### Mobile Terminal 20

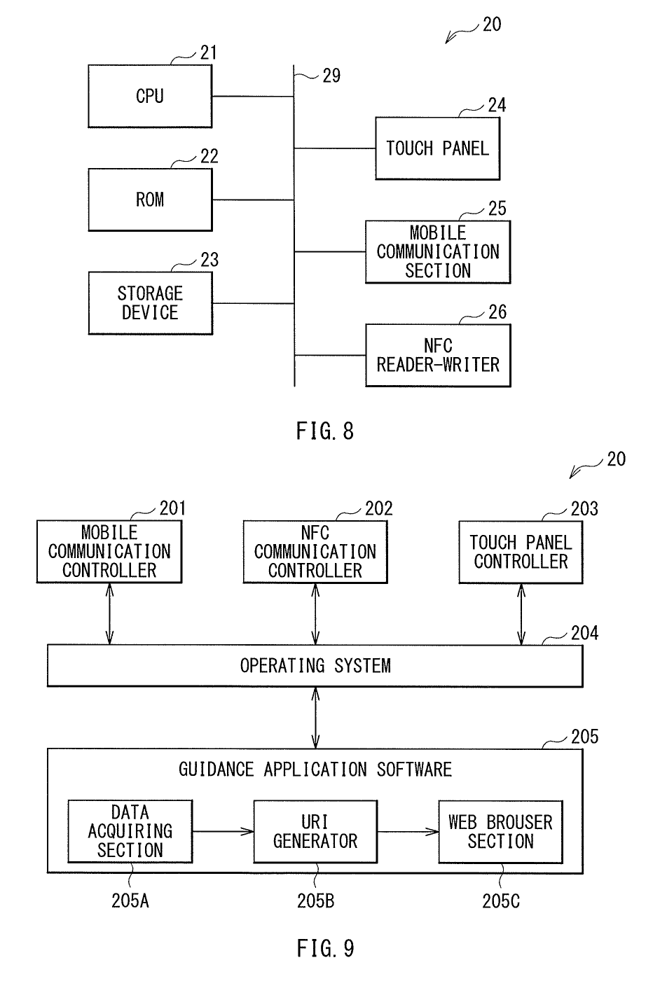

FIG. 8 illustrates an example of a configuration of hardware of the mobile terminal 20. The mobile terminal 20 may include a CPU 21, a RAM 22, a storage device 23, a touch panel 24, a mobile communication section 25, and an NFC reader-writer 26. The CPU 21, the RAM 22, the storage device 23, the touch panel 24, the mobile communication section 25, and the NFC reader-writer 26 may be coupled to each other via an internal bus 29.

The CPU 21 may execute various programs including an operating system and various types of application software. The RAM 22 may temporarily hold data to be used when the CPU 21 executes any of the various programs.

The storage device 23 may be a non-volatile storage device that holds information such as various pieces of data or the various programs including an operating system and various types of application software. The guidance application software 205 which will be described later may be installed on the mobile terminal 20.

The touch panel 24 may display various pieces of information and receive operation performed by the user. The touch panel 24 may include, for example but not limited to, a display device and a touch sensor disposed on a display surface of the display device. Non-limiting examples of the display device may include a liquid crystal display device.

The mobile communication section 25 may perform mobile communication between the mobile communication section 25 and an unillustrated mobile phone base station by means of, for example but not limited to, LTE, 3G, or any other communication technology.

The NFC reader-writer 26 may read the tag information INF from the NFC tag 17 of the image forming apparatus 10 by means of NFC.

FIG. 9 illustrates an example of a configuration of software to be executed by the mobile terminal 20. The mobile terminal 20 may include a mobile communication controller 201, an NFC communication controller 202, a touch panel controller 203, an operating system 204, and the guidance application software 205.

The mobile communication controller 201 may control operation of the mobile communication section 25. The mobile communication controller 201 may thereby cause the mobile communication section 25 to perform communication between the mobile communication section 25 and the unillustrated mobile phone base station and also cause the mobile communication section 25 to be coupled to the Internet INET.

The NFC communication controller 202 may control operation of the NFC reader-writer 26 and thereby cause the NFC reader-writer 26 to read the tag information INF from the NFC tag 17 of the image forming apparatus 10.

The touch panel controller 203 may control operation of the touch panel 24 and thereby cause the touch panel 24 to display information or thereby receive operation performed on the touch panel 24 by the user.

The operating system 204 may be so-called basic software that controls operation of the mobile terminal 20.

The guidance application software 205 may cause the touch panel 24 of the mobile terminal 20 to display guidance information directed to solving an error that has occurred in the image forming apparatus 10. The guidance application software 205 may include a data acquiring section 205A, a URI generator 205B, and a WEB browser section 205C.

The data acquiring section 205A may acquire the tag information INF from the NFC communication controller 202 via the operating system 204.

The URI generator 205B may generate a URI on the basis of the tag information INF acquired by the data acquiring section 205A. The URI may be used upon accessing the FAQ content server 30. For example, in a case where the tag information INF includes the search keyword KW, the URI generator 205B may generate a URI including the search keyword KW included in the tag information INF. In a case where the tag information INF does not include the search keyword KW, the URI generator 205B may generate a URI not including the search keyword KW.

The WEB browser section 205C may access the FAQ content server 30 by means of the URI generated by the URI generator 205B. Further, the WEB browser section 205C may supply, to the touch panel controller 203, page data of a WEB page supplied from the FAQ content server 30. The WEB browser section 205C may thereby cause the touch panel 24 to display the WEB page.

### FAQ Content Server 30

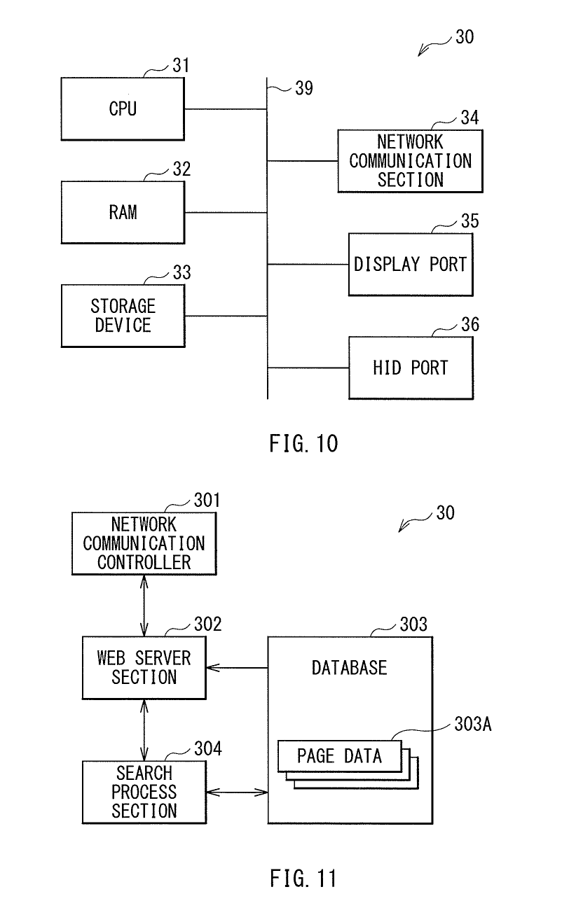

FIG. 10 illustrates an example of a configuration of hardware of the FAQ content server 30. The FAQ content server 30 may include a CPU 31, a RAM 32, a storage device 33, a network communication section 34, a display port 35, and a human interface device (HID) port 36. The CPU 31, the RAM 32, the storage device 33, the network communication section 34, the display port 35, and the HID port 36 may be coupled to each other via an internal bus 39.

The CPU 31 may execute various programs including the operating system and search software that performs a search process utilizing a database. The RAM 32 may temporarily hold data to be used when the CPU 31 executes any of the various programs.

The storage device 33 may be a non-volatile storage device that holds various programs including the operating system and search software. The storage device 33 may also hold a database 303 including a plurality of pieces of page data of content pages related to an answer to a frequently-asked question (FAQ). The database 303 will be described later.

The network communication section 34 may be an NIC that performs communication between the network communication section 34 and the mobile terminal 20 via the Internet INET.

The display port 35 may be coupled to a display device and supply an image signal to the display device. The HID port 36 may be coupled to an input device and receive, from the input device, information corresponding to operation performed by the user. Non-limiting examples of the input device may include a mouse and a keyboard.

FIG. 11 illustrates an example of a configuration of software to be executed by the FAQ content server 30. The FAQ content server 30 may include a network communication controller 301, a WEB server section 302, the database 303, and a search process section 304.

The network communication controller 301 may control operation of the network communication section 34 and thereby cause the network communication section 34 to perform communication between the network communication section 34 and the mobile terminal 20 via the Internet INET.

The WEB server section 302 may supply, to the mobile terminal 20, page data of a WEB page via the Internet INET on the basis of the URI supplied from the mobile terminal 20 via the Internet INET.

The database 303 may include a plurality of pieces of page data 303A of content pages related to an answer to an FAQ. The database 303 may include the page data 303A of a content page related to various models of image forming apparatuses that are described in various languages.

The search process section 304 may, in a case where the URI supplied from the mobile terminal 20 via the Internet INET includes the search keyword KW, perform a search process by means of the database 303 on the basis of the included search keyword KW, the model name information IM, and the language setting information IL. This may cause the WEB server section 302 to supply, via the Internet INET, the mobile terminal 20 with the page data of the WEB page indicating a process result of the performed search process.

The mobile terminal 20 may correspond to a “terminal apparatus” in one specific but non-limiting embodiment of the technology. The NFC reader-writer 26 may correspond to an “acquiring circuitry” in one specific but non-limiting embodiment of the technology. The CPU 21 and the URI generator 205B may correspond to a “generator” in one specific but non-limiting embodiment of the technology. The mobile communication section 25 may correspond to a “communicator” in one specific but non-limiting embodiment of the technology. The touch panel 24 may correspond to a “display” in one specific but non-limiting embodiment of the technology. The model name information IM may correspond to “apparatus information” in one specific but non-limiting embodiment of the technology. The search keyword KW may correspond to “notification information” in one specific but non-limiting embodiment of the technology. The URI may correspond to “search instruction information” in one specific but non-limiting embodiment of the technology.

### Operation and Workings

A description is given below of operation and example workings of the image forming system 1 according to the present embodiment.

### Overview of General Operation

Referring to FIG. 1, a description is given of an overview of general operation of the image forming system 1. For example, when an error occurs, the image forming apparatus 10 may display an error message on the basis of the error information table 106A and the error identifier EID associated with the error. Further, in response to the user's operating the help button 15E of the image forming apparatus 10, the image forming apparatus 10 may display a help message on the basis of the help information table 106B. In a case where the image forming apparatus 10 obtains the search keyword KW other than “NULL” on the basis of the help information table 106B, the image forming apparatus 10 may write, on the NFC tag 17 illustrated in FIG. 2, the tag information INF including the search keyword KW other than “NULL”.

Further, in response to the user's placing the mobile terminal 20 over the image forming apparatus 10, the mobile terminal 20 may acquire the tag information INF from the image forming apparatus 10 by means of NFC. Further, the mobile terminal 20 may generate, on the basis of the acquired tag information INF, a URI to be used upon accessing the FAQ content server 30. For example, in a case where the tag information INF includes the search keyword KW, the mobile terminal 20 may generate a URI including the search keyword KW included in the tag information INF. In a case where the tag information INF does not include the search keyword KW, the mobile terminal 20 may generate a URI including no search keyword KW. Further, the mobile terminal 20 may access the FAQ content server 30 with the use of the generated URI via the Internet INET.

The FAQ content server 30 may supply the mobile terminal 20 with the page data of the WEB page via the Internet INET on the basis of the URI supplied from the mobile terminal 20. Further, the mobile terminal 20 may display the WEB page supplied from the FAQ content server 30.

### Detailed Operation

A detailed description is given below of operation of the image forming apparatus 10 and operation of the mobile terminal 20, in this order, in a case where an error occurs in the image forming apparatus 10.

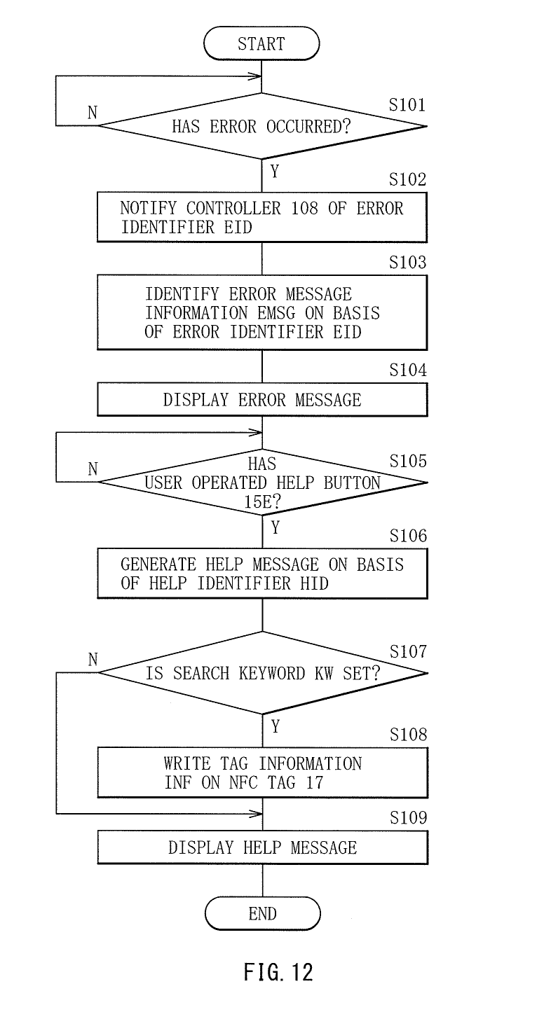

FIG. 12 illustrates an example of the operation of the image forming apparatus 10. For example, when an error occurs, the image forming apparatus 10 may display an error message on the basis of the error information table 106A and the error identifier EID associated with the error. Further, in response to the user's operating the help button 15E of the image forming apparatus 10, the image forming apparatus 10 may display a help message on the basis of the help information table 106B and write the tag information INF on the NFC tag 17. This operation is described in detail below.

First, the network communication controller 101, the reception controller 102, the image formation controller 103, and the hardware monitoring section 104 may confirm whether an error has occurred (step S101). When none of the network communication controller 101, the reception controller 102, the image formation controller 103, and the hardware monitoring section 104 confirms occurrence of an error (“N” in step S101), the process in step S101 may be performed repeatedly. When any of the network communication controller 101, the reception controller 102, the image formation controller 103, and the hardware monitoring section 104 confirms occurrence of an error (“Y” in step S101), the one that has detected the error may notify the controller 108 of the error identifier EID associated with the error (step S102).

Thereafter, the error information manager 106 may identify the error message information EMSG related to the error identifier EID supplied from the controller 108, on the basis of the supplied error identifier EID, by means of the error information table 106A (step S103).

Thereafter, the operation panel controller 105 may cause the display section 15A of the operation panel 15 to display an error message on the basis of the error message information EMSG specified in step S103 (step S104).

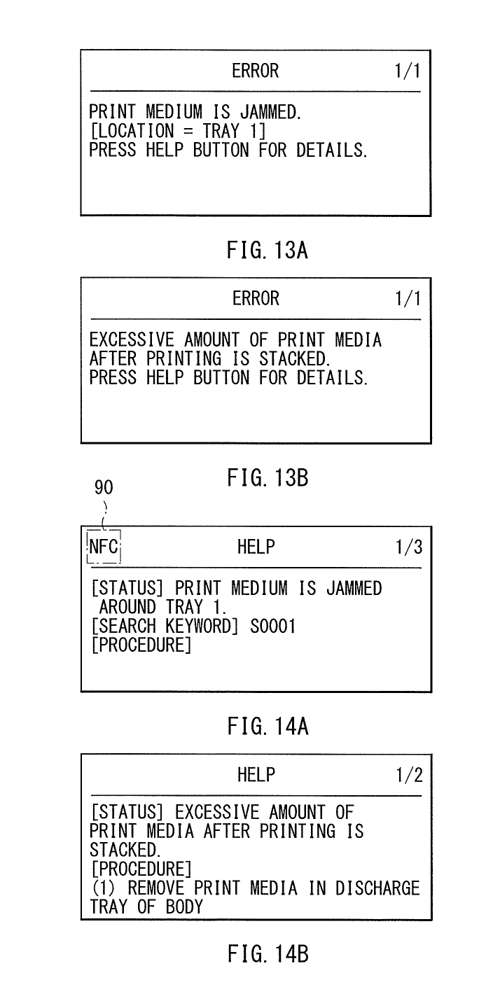

FIGS. 13A and 13B each illustrate an example of an error message to be displayed on the display section 15A. FIG. 13A illustrates an example of an error message, to be displayed on the display section 15A, indicating that the print medium is jammed in “Tray 1”. FIG. 13B illustrates an example of an error message, to be displayed on the display section 15A, indicating that an excessive amount of the print media after printing is stacked in the discharge tray. The error message illustrated in FIG. 13A may be displayed on the basis of the error message information EMSG related to the error identifier EID of “E0001” in the error information table 106A illustrated in FIG. 5. The error message illustrated in FIG. 13B may be displayed on the basis of the error message information EMSG related to the error identifier EID of “E0021” in the error information table 106A.

In this example, as illustrated in FIGS. 13A and 13B, information indicating that the displayed content is an error message may be displayed at an upper portion of the display screen of the display section 15A. In this example, “Error” may be displayed at the upper portion of the display screen of the display section 15A. Further, the error message may be displayed below the information indicating that the displayed content is an error message.

Thereafter, the operation panel controller 105 may confirm whether the user has operated the help button 15E (step S105). When the user has not operated the help button 15E (“N” in step S105), the process in step S105 may be performed repeatedly.

When the user has operated the help button 15E in step S105 (“Y” in step S105), the error information manager 106 may generate a help message on the basis of the help identifier HID (step S106). For example, the error information manager 106 may identify the help identifier HID and the argument information ARG that are related to the error identifier EID supplied from the controller 108. The error information manager 106 may perform the above-described identification by means of the error information table 106A. Further, the error information manager 106 may identify the help message information HMSG and the search keyword KW that are related to the identified help identifier HID on the basis of the identified help identifier HID. The error information manager 106 may perform the above-described identification by means of the help information table 106B. Further, the error information manager 106 may replace the “% VARIABLE %” part included in the help message information HMSG with a character string indicated by the argument information ARG The error information manager 106 may also replace the “% SEARCHWORD %” part included in the help message information HMSG with a character string indicated by the search keyword KW. The error information manager 106 may thereby generate the help message. In a case where the argument information ARG is not set, the help message information HMSG may not include the “% VARIABLE %” part. Therefore, the error information manager 106 may not perform the replacement with a character string. In a case where the search keyword KW is not set, the help message information HMSG may not include the “% SEARCHWORD %”. Therefore, the error information manager 106 may not perform the replacement with a character string.

Thereafter, the error information manager 106 may confirm whether the search keyword KW is set (step S107). When the search keyword KW is not set (“N” in step S107), the flow may proceed to step S109.

When the search keyword KW is set in step S107 (“Y” in step S107), the NFC tag controller 107 may write, on the NFC tag 17, the tag information INF including the set search keyword KW as well as the model name information IM, the language setting information IL, and the application software identifier SID that are stored in the storage device 14 (step S108).

Thereafter, the operation panel controller 105 may cause the display section 15A of the operation panel 15 to display the help message generated in step S106 (step S109).

FIGS. 14A and 14B each illustrate an example of a help message to be displayed on the display section 15A. FIG. 14A illustrates an example of a help message, to be displayed on the display section 15A, indicating that the print medium is jammed in “Tray 1”. FIG. 14B illustrates an example of a help message, to be displayed on the display section 15A, indicating that an excessive amount of the print media after printing is stacked in the discharge tray. The help message illustrated in FIG. 14A may be displayed on the basis of the help message information HMSG related to the help identifier HID of “H0001” in the help information table 106B illustrated in FIG. 6. The help message illustrated in FIG. 14B may be displayed on the basis of the help message information HMSG related to the help identifier HID of “H0021” in the help information table 106B.

In this example, as illustrated in FIGS. 14A and 14B, information indicating that the displayed content is a help message may be displayed at the upper portion of the display screen of the display section 15A. In this example, “Help” may be displayed at the upper portion of the display screen of the display section 15A. Further, the help message may be displayed below the information indicating that the displayed content is a help message. Unlike the error message, the help massage may carry a lot of information in some cases as the help message includes information directed to solving of an error. In this case, not all of the help messages are displayable at once on the display screen of the display section 15A. In such a case, the display section 15A may display part of the help message. Further, in response to the operation performed by the user on the cursor key 15B, the display section 15A may change the part, of the help message, to be displayed. Information related to the currently-displayed part, e.g., the currently-displayed page, of the help message as a whole may be displayed on an upper-right portion of the display screen. In this example, “1/3” may be displayed on the upper-right portion of the display screen.

Moreover, in the example illustrated in FIG. 14A, a notice 90 indicating that guidance information is acquirable by means of the FAQ content server 30 may be displayed on an upper-left portion of the display screen. In this example, “NFC” may be displayed on the upper-left portion of the display screen. In other words, in the example illustrated in FIG. 14A, the search keyword KW may be set. In this example, “S0001” may be set to the search keyword KW. Therefore, the user is allowed to acquire, from the FAQ content server 30, guidance information directed to solving of the error, with the use of the mobile terminal 20. The user may understand, by confirming the notice 90, that the guidance information is acquirable by means of the FAQ content server 30 with the use of the mobile terminal 20. In contrast, in the example illustrated in FIG. 14B, the search keyword KW may not be set. Therefore, the notice 90 may not be displayed on the display screen.

This may bring the flow to an end.

As described above, on a condition that the user operates the help button 15E and the error information manager 106 acquires the search keyword KW other than “NULL”, the image forming apparatus 10 may write the tag information INF including the search keyword KW on the NFC tag 17. Further, in response to the user's placing the mobile terminal 20 over the image forming apparatus 10, the mobile terminal 20 may acquire the tag information INF from the image forming apparatus 10 by means of NFC. A description is given below of operation of the mobile terminal 20 after the mobile terminal 20 acquires the tag information INF.

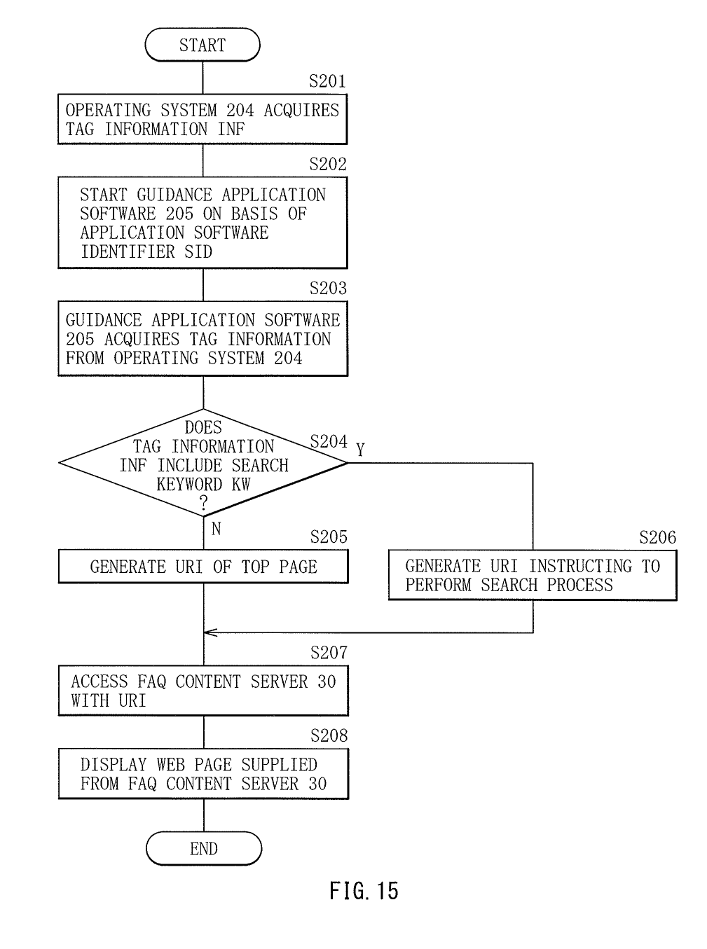

FIG. 15 illustrates an example of operation of the mobile terminal 20. The mobile terminal 20 may acquire the tag information INF from the image forming apparatus 10. Further, the mobile terminal 20 may generate, on the basis of the acquired tag information INF, a URI to be used upon accessing the FAQ content server 30. Further, the mobile terminal 20 may access the FAQ content server 30 via the Internet INET with the use of the generated URI, and display the WEB page supplied from the FAQ content server 30. A detailed description is given below of this operation.

First, the operating system 204 may acquire the tag information INF (step S201). For example, first, the NFC communication controller 202 may cause the NFC reader-writer 26 to read the tag information INF from the NFC tag 17 of the image forming apparatus 10. Further, the operating system 204 may acquire the read tag information INF.

Thereafter, the operating system 204 may start the guidance application software 205 on the basis of the application software identifier SID included in the tag information INF (step S202). The guidance application software 205 may be application software associated with the application software identifier SID included in the tag information INF. In a case where the guidance application software 205 is not installed on the mobile terminal 20, for example, the user may be automatically guided to a delivery server managed by a vendor of the operating system 204. Thereby, the user is allowed to install the guidance application software 205 on the mobile terminal 20 by simple operation.

Thereafter, the data acquiring section 205A of the guidance application software 205 may acquire the tag information INF from the operating system 204 (step S203).

Thereafter, the URI generator 205B may confirm whether the tag information INF includes the search keyword KW (step S204).

When the tag information INF does not include the search keyword KW in step S204 (“N” in step S204), the URI generator 205B may generate a URI of a top page of the FAQ content server 30 (step S205). The following may be a non-limiting example of the URI.
http://www.printer.com/xxx/faq/?model=yyy
   In this example, “xxx” may be the language setting information IL, and “yyy” may be the model name information IM. For example, “xxx” may be “ja”. For example, “yyy” may be “Model01”.

When the tag information INF includes the search keyword KW in step S204 (“Y” in step S204), the URI generator 205B may generate a URI instructing the FAQ content server 30 to perform the search process (step S206). The following may be a non-limiting example of the URI.
http://www.printer.com/xxx/faq/?model=yyy&keyword=zzz
   In this example, “zzz” may be the search keyword KW included in the tag information INF.

Thereafter, the WEB browser section 205C may access the FAQ content server 30 with the use of the URI generated by the URI generator 205B in one of step S205 and step S206 (step S207).

The FAQ content server 30 may generate page data of a WEB page on the basis of the URI supplied from the mobile terminal 20. Further, the FAQ content server 30 may supply the generated page data to the mobile terminal 20 via the Internet INET. For example, the WEB server section 302 of the FAQ content server 30 may receive the URI supplied from the mobile terminal 20.

When the URI does not include the search keyword KW, the WEB server section 302 may generate page data of a WEB page on which the user is allowed to input a search keyword.

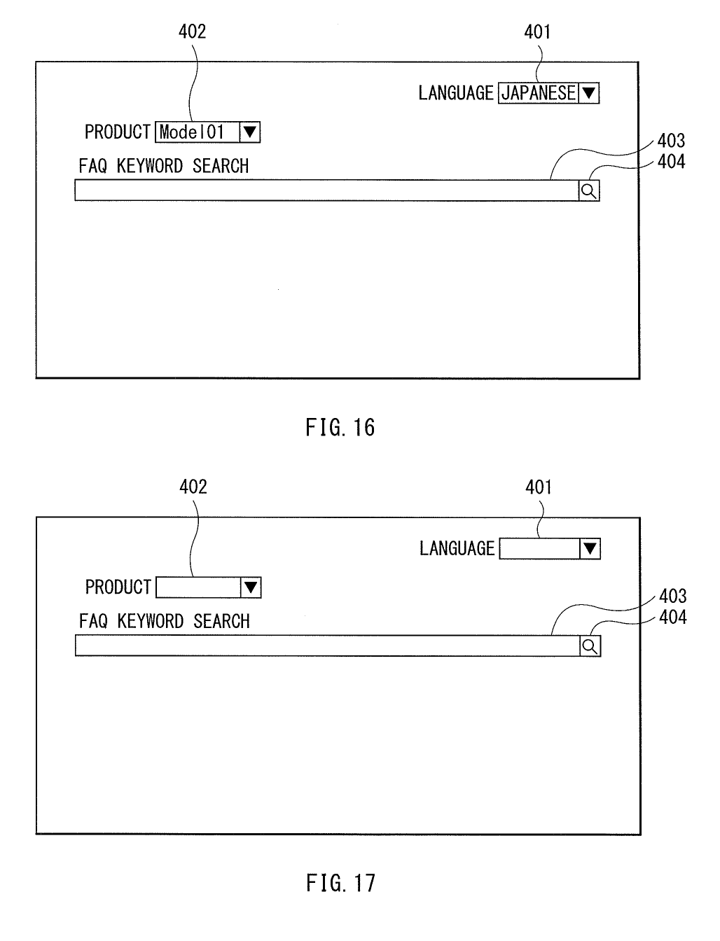

FIG. 16 illustrates a WEB page generated by the WEB server section 302 in a case where the URI does not include the search keyword KW. The WEB page may include a pulldown menu 401, a pulldown menu 402, a text box 403, and a search button 404. The pulldown menu 401 may be operated by the user when the user selects the language to be used on the display. The WEB server section 302 may set an initial value of the pulldown menu 401 on the basis of the language setting information IL included in the URI. For example, in a case where the URI includes the language setting information IL indicating “ja”, the WEB server section 302 may set the initial value of the pulldown menu 401 to “Japanese”. The pulldown menu 402 may be operated by the user when the user selects the model name of the image forming apparatus whose information the user attempts to obtain. The WEB server section 302 may set an initial value of the pulldown menu 402 on the basis of the model name information IM included in the URI. For example, in a case where the URI includes the model name information IM indicating “Model01”, the WEB server section 302 may set the initial value of the pulldown menu 402 to “Model01”. The text box 403 may be an input field in which a search keyword is to be input. In this example, the URI does not include the search keyword KW. Therefore, the user may be allowed to input a search keyword by means of the text box 403. The search button 404 may be operated by the user when the user gives an instruction to start searching. In response to the user's operating the search button 404, the search process section 304 may perform a search process by means of the database 303 on the basis of the information set in the pulldown menu 401, the pulldown menu 402, and the text box 403.

It is to be noted that, for example, in a case where a device such as the mobile terminal 20 or an information processor has accessed the FAQ content server 30, for example, with the use of the URI including only a domain name, the WEB server section 302 may generate a WEB page illustrated in FIG. 17. In this case, the URI may include none of the language setting information IL, the model name information IM, and the search keyword KW, the initial values of the respective pulldown menus 401 and 402 may not be set and may be left blank. The user may be allowed to select, by operating the pulldown menu 401, the language to be used on the display. Similarly, the user may be allowed to obtain, by operating the pulldown menu 402, the model name of the image forming apparatus whose information the user attempts to obtain.

In a case where the URI includes the search keyword KW, the search process section 304 may perform the search process by means of the database 303 on the basis of the search keyword KW. Further, the WEB server section 302 may generate page data of a WEB page indicating a process result of the performed search process.

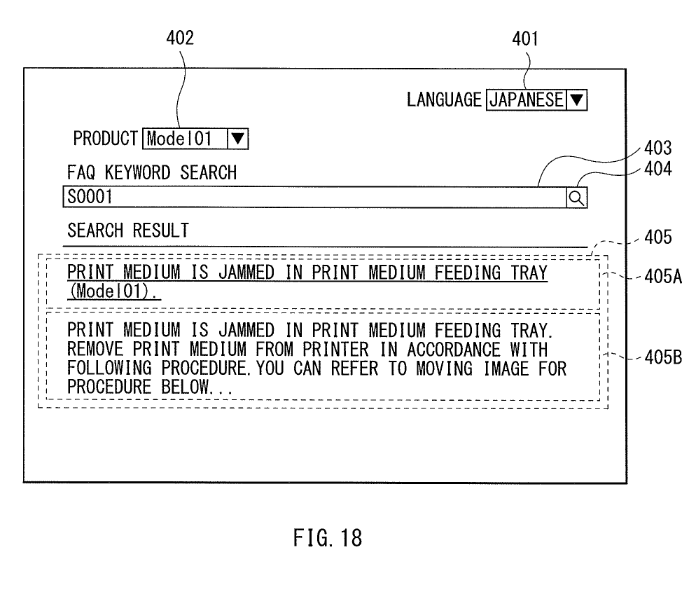

FIG. 18 illustrates a WEB page generated by the WEB server section 302 in a case where the URI includes the search keyword KW. The WEB page may include the pulldown menu 401, the pulldown menu 402, the text box 403, the search button 404, and a search result display field 405. The WEB server section 302 may set the initial value of the pulldown menu 401, i.e., “Japanese” in this example, on the basis of the language setting information IL included in the URI. The WEB server section 302 may also set the initial value of the pulldown menu 402, i.e., “Model01” in this example, on the basis of the model name information IM included in the URI. Further, the WEB server section 302 may set an initial value of the text box 403 on the basis of the search keyword KW included in the URI. For example, in a case where the URI includes the search keyword KW indicating “S0001”, the WEB server section 302 may set the initial value of the text box 403 to “S0001”. The search result display field 405 may be a field that displays a search result. In this example, the URI may include the language setting information IL, the model name information IM, and the search keyword KW. Therefore, the search process section 304 may perform the search process by means of the database 303 on the basis of the language setting information IL, the model name information IM, and the search keyword KW included in the URI. Further, the WEB server section 302 may cause a list of a result of the performed search process to be displayed in the search result display field 405. In this example, a single hit leading to a single piece of information may have been obtained as a result of the search process, and the search result display field 405 may therefore display the single piece of information. However, this is non-limiting. In a case where a plurality of hits leading to a plurality of pieces of information have been obtained as the result of the search process, the search result display field 405 may display a list including the plurality of pieces of information. The search result display field 405 may include a title display field 405A and a summary display field 405B. The title display field 405A may display a title of a content page obtained as a hit as a result of the search process. The summary display field 405B may display a summary of the content page. A hyperlink directed to displaying the content page may be set in the title display field 405A.

The FAQ content server 30 may generate page data of the above-described WEB page on the basis of the URI supplied from the mobile terminal 20. Further, the FAQ content server 30 may supply the generated page data to the mobile terminal 20 via the Internet INET.

Thereafter, the WEB browser section 205C may cause the WEB page supplied from the FAQ content server 30 to be displayed (step S208).

This may bring the flow to an end.

For example, in a case where the user operates the title display field 405A on the WEB page illustrated in FIG. 18, the content page may be displayed on the basis of the set hyperlink.

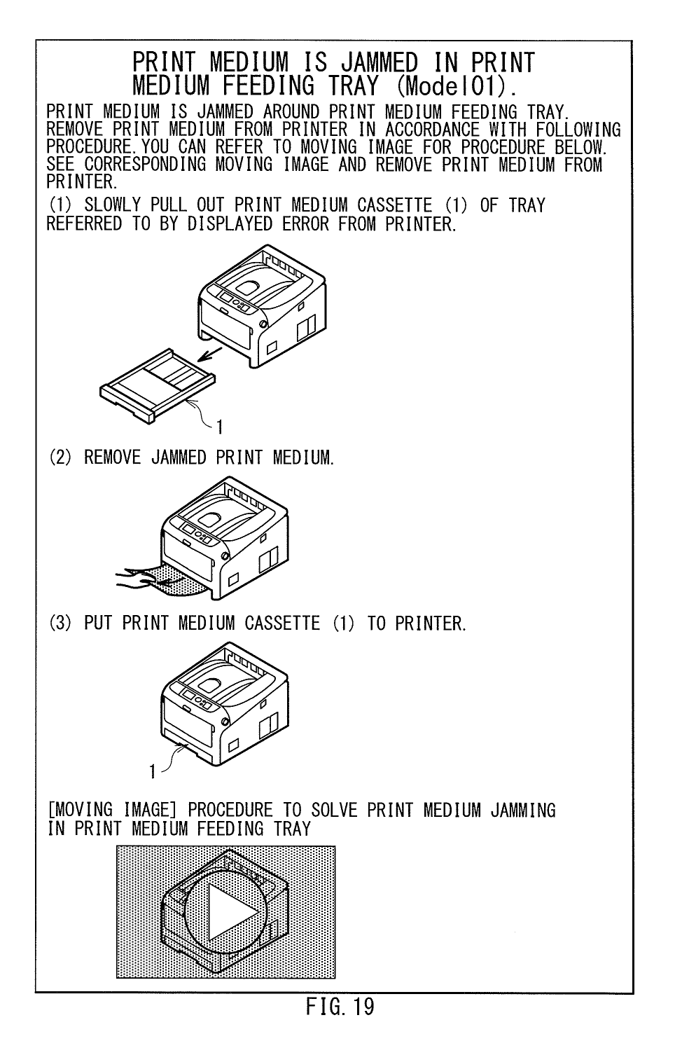

FIG. 19 illustrates an example of a content page. The content page may include guidance information directed to solving of an error of a case where the print medium is jammed in a print medium feeding tray. The guidance information may include a link to a moving image indicating a procedure of operation directed to solving of the error.

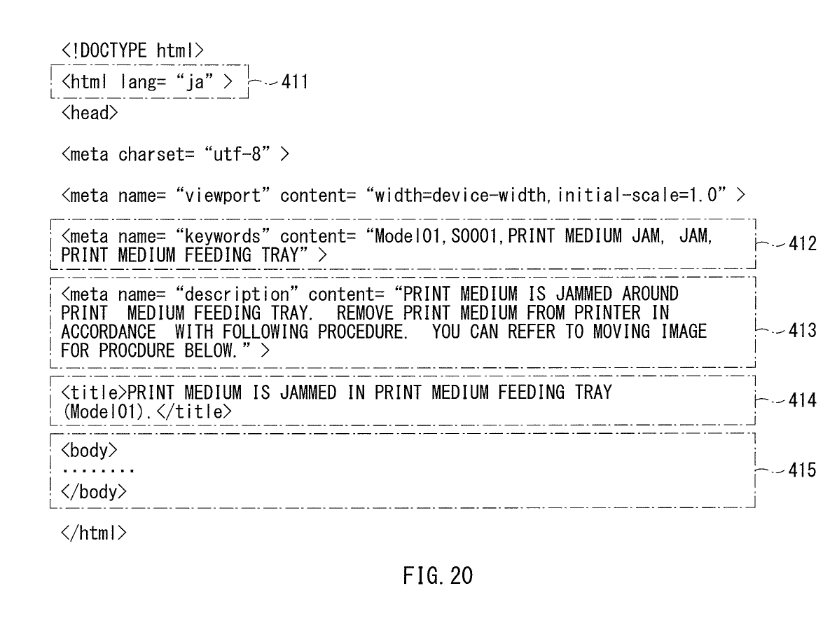

FIG. 20 illustrates an example of the page data 303A of the content page illustrated in FIG. 19. The page data 303A may be stored in the database 303. The search process section 304 may search the page data 303A, and the page data 303A may be supplied to the mobile terminal 20. The page data 303A may be described in hypertext markup language (HTML). For example, the page data 303A may be created in consideration of being displayed on a display screen with a small width. The display screen with a small width may be, for example but not limited to, a display screen of a smartphone. In a description 411 of the page data 303A, a language may be set. In this example, the language may be set to “ja”. The description 411 may be a target of searching at the time when the search process section 304 performs the search process on the basis of the language setting information IL. In a description 412, a keyword may be set as metadata. In this example, “Model01”, “S0001”, “print medium jam”, “jam”, and “print medium feeding tray” may be set as the metadata in the description 412. The description 412 may be a target of searching at the time when the search process section 304 performs the search process on the basis of the search keyword KW and the model name information IM. In a description 413, a summary of the content page may be set as metadata. The summary may be displayed in the summary display field 405B illustrated in FIG. 18 of the search result display field 405. In a description 414, a title of the content page may be set. The title may be displayed in the title display field 405A illustrated in FIG. 18 of the search result display field 405. In a description 415, the guidance information illustrated in FIG. 19 may be presented.

As described above, in the image forming system 1, the mobile terminal 20 may acquire, for example, the tag information INF including the search keyword KW from the image forming apparatus 10 having an error. Further, the mobile terminal 20 may generate the URI including the search keyword KW included in the acquired tag information INF on the basis of the tag information INF. Further, the mobile terminal 20 may access the FAQ content server 30 with the use of the generated URI. This allows the user to obtain, from the FAQ content server 30, guidance information directed to solving of the error that has occurred in the image forming apparatus 10. Hence, user friendliness is increased.

Moreover, in the image forming system 1, in a case where the user operates the help button 15E, the image forming apparatus 10 may write the tag information INF on the NFC tag 17. This suppresses the number of times that re-writing of data is performed on the NFC tag 17 in the image forming system 1. For example, in a case where the tag information INF is written on the NFC tag 17 each time an error occurs in the image forming apparatus, the number of times that re-writing of data is performed may be greater. Accordingly, for example, in a case where an upper limit is set for the number of times that the re-writing of data is performed on a non-volatile memory of the NFC tag 17, the actual number of times that re-writing of data is performed may possibly exceed the set upper limit in a short time. This may make the NFC tag 17 non-usable. In contrast, in the image forming system 1, the tag information INF may be written on the NFC tag 17 in a case where the user operates the help button 15E. This suppresses the number of times that re-writing of data is performed. As a result, the possibility of making the NFC tag 17 non-usable is decreased. Hence, user friendliness is increased.

For example, on a condition that the user operates the help button 15E and the error information manager 106 obtains the search keyword KW other than “NULL”, the tag information INF may be written on the NFC tag 17. Therefore, the number of times that the re-writing of data is performed is further suppressed. Hence, user friendliness is increased.

Moreover, in the image forming system 1, the guidance application software 205 installed on the mobile terminal 20 may generate the URI on the basis of the tag information INF acquired from the image forming apparatus 10. Accordingly, for example, also in a case where the configuration of the FAQ content server 30 is changed, adapting to the change in the configuration of the FAQ content server 30 may be allowed by updating the guidance application software 205 installed on the mobile terminal 20. The change in the configuration of the FAQ content server 30 may be, for example but not limited to, a change in the domain name of the FAQ content server 30. Hence, friendliness to the vendor of the image forming apparatus 10 is increased. For example, in a case where the image forming apparatus is configured to generate the URI, it may be necessary to update firmware of the image forming apparatus when the configuration of the FAQ content server 30 is changed. It is difficult, however, to update the firmware of many general image forming apparatuses. In other words, many image forming apparatuses are set to be non-accessible to the Internet. Therefore, it may be difficult to update the firmware of all of the image forming apparatuses commercially available. In contrast, it may be easy to update software of a mobile terminal automatically or manually by accessing a delivery server managed by a vendor of an operating system used in the mobile terminal. In the image forming system 1, the guidance application software 205 may generate the URI on the basis of the tag information INF acquired from the image forming apparatus 10. Accordingly, for example, also in a case where the configuration of the FAQ content server 30 is changed, adapting to the change in the configuration of the FAQ content server 30 may be allowed by easily updating the guidance application software 205. As a result, it is possible to increase friendliness to the vendor of the image forming apparatus 10.

Moreover, in a case where the image forming apparatus is configured to generate the URI, for example, a redirect server may be prepared to allow the image forming apparatus to access the FAQ content server 30 via the redirect server. This may allow for adapting to a change in the configuration of the FAQ content server 30 by changing a setting of the redirect server, in a case where the configuration of the FAQ content server 30 is changed. However, this case may require some costs for the redirect server such as a cost for constructing the redirect server or a cost for operating the redirect server. In contrast, in the image forming system 1, the guidance application software 205 may generate the URI on the basis of the tag information INF acquired from the image forming apparatus 10. This configuration may use no redirect server described above. Therefore, the cost is reduced. Further, in a case where the configuration of the FAQ content server 30 is changed, partial modification of the guidance application software 205 may be sufficient. Therefore, the cost is suppressed. As a result, friendliness to the vendor of the image forming apparatus 10 is increased.

Moreover, in the image forming system 1, in a case where the guidance information is acquirable by means of the FAQ content server 30, the notice 90 may be displayed on the operation panel 15 of the image forming apparatus 10 as illustrated in FIG. 14A. In the example illustrated in FIG. 14A, “NFC” may be displayed on the operation panel 15 of the image forming apparatus 10. Accordingly, it is sufficient for the user to place the mobile terminal 20 over the image forming apparatus 10 on an as-needed basis only in a case where the notice 90 is displayed. Hence, user friendliness is increased.

Moreover, in the image forming system 1, in a case where the URI supplied from the mobile terminal 20 includes the search keyword KW, the search process section 304 may perform the search process by means of the database 303 on the basis of the search keyword KW included in the URI. This may save an effort of the user. Hence, user friendliness is increased.

For example, in the image forming system 1, the search keyword KW may be an identification code including a character such as an alphabet or a number and having no specific meaning. Non-limiting examples of the search keyword KW as that described above may include “S0001”. Therefore, for example, a single hit leading to a single content page may have been obtained on the basis of the search keyword KW in the search process. For example, in a case where a usual keyword such as “jam” is used, a plurality of hits leading to a plurality of content pages may be obtained in the search process. This may require the user to look for a desired content page among the plurality of content pages, which may possibly require more effort of the user. In contrast, in the image forming system 1, the search keyword KW may be the identification code having no specific meaning. This reduces the number of hits obtained in the search process, reducing the effort of the user to look for the desired content page. Hence, user friendliness is increased.

### Example Effects

In one example embodiment described above, a mobile terminal may acquire, for example, tag information including a search keyword, from an image forming apparatus having an error. The mobile terminal may generate an URI including the keyword on the basis of the acquired tag information. The mobile terminal may access an FAQ content server with the use of the generated URI. As a result, the user is allowed to obtain, from the FAQ content server, guidance information directed to solving of the error in the image forming apparatus. Hence, it is possible to increase user friendliness.

In the present example embodiment, guidance application software installed on the mobile terminal may generate the URI on the basis of the tag information acquired from the image forming apparatus. As a result, also in a case where a configuration of the FAQ content server is changed, adapting to the change in the configuration of the FAQ content server is allowed by updating the guidance application software. Hence, it is possible to increase friendliness to a vendor of the image forming apparatus.

In the present example embodiment, in a case where the user operates a help button, the image forming apparatus may write the tag information on an NFC tag. As a result, the number of times that re-writing of data is performed on the NFC tag is suppressed. Hence, it is possible to increase user friendliness.

### Modification Example 1

In the example embodiment described above, the search process section 304 may perform the search process targeting the page data 303A of the plurality of content pages stored in the database 303; however, this is non-limiting. In an alternative example, an index file may be provided that relates a file name of page data and a keyword to each other and hold the file name of the page data and the keyword. Further, the search process section may obtain page data associated with the search keyword KW by means of the index file. In this case, for example, the description 412 illustrated in FIG. 20 may not be provided for each page data.

### Modification Example 2

In the example embodiment described above, the image forming apparatus 10 may generate, for example, the tag information INF including the search keyword KW, and the mobile terminal 20 may generate the URI including the search keyword KW included in the tag information INF on the basis of the tag information INF; however, this is non-limiting. A detailed description is provided below of an image forming system 1B according to Modification example 2. The image forming system 1B may include an image forming apparatus 10B, the information processor 9, a mobile terminal 20B, and the FAQ content server 30.

The image forming apparatus 10B may include an NFC tag controller 107B as with the image forming apparatus 10 illustrated in FIG. 4 according to the example embodiment described above. The NFC tag controller 107B may write tag information INF2 on the NFC tag 17 in NDEF on the basis of an instruction given from the controller 108.

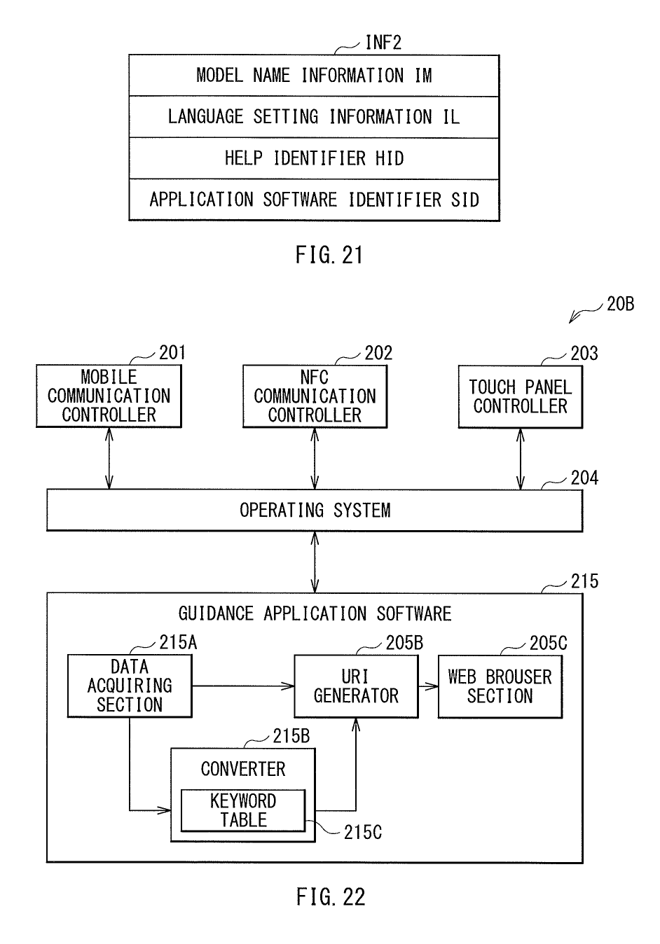

FIG. 21 illustrates an example of the tag information INF2. In this example, the tag information INF2 may include the model name information IM, the language setting information IL, the help identifier HID, and the application software identifier SID.

For example, the NFC tag controller 107B may write the tag information INF2 on the NFC tag 17 when the image forming apparatus 10B is turned on. In this case, a record related to the help identifier HID of the tag information INF2 may be blank. In other words, the tag information INF2 may not include the help identifier HID in this case. Further, for example, in a case where the user operates the help button 15E of the operation panel 15, the NFC tag controller 107B may write, on the NFC tag 17, the tag information INF2 including the help identifier HID.

FIG. 22 illustrates an example of a configuration of software to be executed in the mobile terminal 20B. The mobile terminal 20B may include the guidance application software 215. The guidance application software 215 may include a data acquiring section 215A and a converter 215B.

The data acquiring section 215A may acquire the tag information INF2 from the NFC communication controller 202 via the operating system 204.

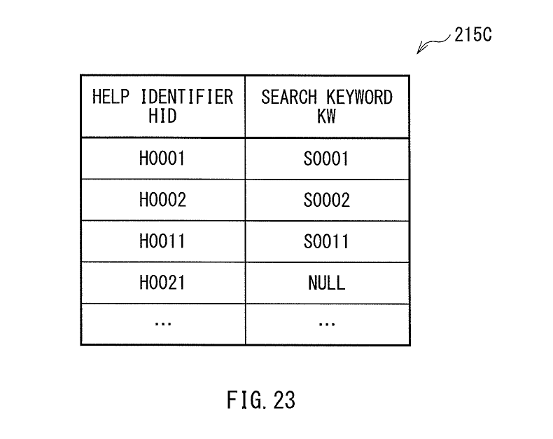

The converter 215B may convert, into the search keyword KW, the help identifier HID included in the tag information INF2 acquired by the data acquiring section 215A. The converter 215B may include a keyword table 215C. The keyword table 215C may hold the help identifier HID and the search keyword KW that are related to each other, as illustrated in FIG. 23. The converter 215B may identify the search keyword KW related to the help identifier HID. The converter 215B may perform the above-described identification, on the basis of the help identifier HID, by means of the keyword table 215C.

Further, the URI generator 205B may generate a URI on the basis of the search keyword KW obtained by the converter 215B as well as the model name information IM and the language setting information IL both included in the tag information INF acquired by the data acquiring section 215A.

The configuration described above may allow for, for example, in a case where the configuration of the FAQ content server 30 is changed, adapting to the change in the configuration of the FAQ content server 30 by updating the guidance application software 215 installed on the mobile terminal 20B. Hence, it is possible to increase friendliness to a vendor of the image forming apparatus 10B.

In the example described above, the tag information INF2 may include the help identifier HID; however, this is non-limiting. In an alternative example, the tag information INF2 may include the error identifier EID. In this case, for example, the keyword table 215C of the mobile terminal 20B may hold the error identifier EID and the search keyword KW that are related to each other.

### Modification Example 3

In the example embodiment described above, when a single hit leading to a single piece of information is obtained as a result of the search process performed by the search process section 304, the WEB server section 302 may display the single piece of information in the search result display field 405, as illustrated in FIG. 18; however, this is non-limiting. In an alternative example, when only a single hit leading to a single piece of information is obtained as a result of the search process, the WEB server section 302 may supply the content page illustrated in FIG. 19 to the mobile terminal 20 instead of supplying the WEB page illustrated in FIG. 18 to the mobile terminal 20, for example.

### Other Modification Examples

Two or more of the modification examples described above may be adopted in combination.

The technology has been described above referring to the example embodiment and the modification examples thereof. However, the technology is not limited to the example embodiment and the modification examples described above, and is modifiable in various ways.

For example, in the example embodiment and the modification examples described above, the tag information INF may include the model name information IM, the language setting information IL, the search keyword KW, and the application software identifier SID; however, this is non-limiting and the tag information INF may further include any other information. For example, the tag information INF may also include information related to a serial number of the image forming apparatus 10, information related to a time at which the image forming apparatus 10 has displayed a help message, and detailed information related to an error having occurred in the image forming apparatus 10. The mobile terminal 20 may also supply, when accessing the FAQ content server 30, the foregoing pieces of information to the FAQ content server 30. The FAQ content server 30 may accumulate the supplied pieces of information. For example, this may allow the vendor of the image forming apparatus 10 to comprehend, on the basis of the information accumulated in the FAQ content server 30, the time of occurrence of the error and the type of the error related to each of the numerous commercially-available image forming apparatuses. Accordingly, for example, in a case where the user finds it difficult or unable to solve an error even after confirming the guidance information supplied from the FAQ content server 30 and makes an inquiry at a maintenance service of the vendor about the error, a person of the vendor in charge may comprehend more detailed information related to the error in the image forming apparatus 10 of the user on the basis of the serial number of the image forming apparatus 10 provided by the user. As a result, quality of the maintenance service is improved. Hence, it is possible to increase user friendliness. Moreover, efficiency of the maintenance service is improved. Hence, it is possible to reduce a cost such as a personnel expense of the vendor.

Furthermore, the technology encompasses any possible combination of some or all of the various embodiments and the modifications described herein and incorporated herein. It is possible to achieve at least the following configurations from the above-described example embodiments of the technology.

(1)

A terminal apparatus including:

an acquiring circuitry that acquires, from an image forming apparatus having a trouble, apparatus information related to the image forming apparatus and notification information corresponding to the trouble;

a generator that generates search instruction information on the basis of the apparatus information and the notification information both acquired by the acquiring circuitry, the search instruction information including a search keyword to be used in a search server;

a communicator that acquires a search result related to the trouble by accessing the search server with use of the search instruction information; and

a display that displays the search result.

(2)

The terminal apparatus according to (1), in which the generator generates the search instruction information by executing application software.

(3)

The terminal apparatus according to (1) or (2), in which the notification information includes the search keyword to be used in the search server.

(4)

The terminal apparatus according to (1) or (2), in which the generator converts the notification information into the search keyword and generates the search instruction information on the basis of the apparatus information and the search keyword.

(5)

The terminal apparatus according to any one of (1) to (4), in which the communicator performs network communication between the communicator and the search server, and

the search instruction information includes a uniform resource identifier.

(6)

The terminal apparatus according to any one of (1) to (5), in which the search result includes information indicating a list of a result of searching performed by the search server.

(7)

The terminal apparatus according to any one of (1) to (5), in which the search result includes content information indicating a way to deal with the trouble.

(8)

The terminal apparatus according to any one of (1) to (7), in which

the apparatus information and the notification information are written on an integrated circuit tag of the image forming apparatus, and

the acquiring circuitry acquires the apparatus information and the notification information from the integrated circuit tag.

(9)

An image forming system including:

an image forming apparatus that forms an image on a print medium;

a search server that provides content information based on a search keyword by performing a search process; and

a terminal apparatus,

the terminal apparatus including
an acquiring circuitry that acquires from the image forming apparatus, when the image forming apparatus is having a trouble, apparatus information related to the image forming apparatus and notification information corresponding to the trouble,
a generator that generates search instruction information on the basis of the apparatus information and the notification information both acquired by the acquiring circuitry, the search instruction information including the search keyword,
a communicator that acquires a search result related to the trouble by accessing the search server with use of the search instruction information, and
a display that displays the search result.
   (10)

The image forming system according to (9), in which

the image forming apparatus includes an integrated circuit tag and an operation section that receives operation performed by a user,

the image forming apparatus writes the apparatus information and the notification information on the integrated circuit tag on the basis of an instruction given from the operation section when the trouble occurs, and

the acquiring circuitry of the terminal apparatus acquires the apparatus information and the notification information from the integrated circuit tag.

(11)

The image forming system according to (9) or (10), in which

the search server includes a plurality of pieces of content information,

when two or more pieces of content information related to the search keyword are identified of the plurality of pieces of content information by performing the search process, the search server supplies the terminal apparatus with a list of the two or more pieces of content information, and

when a single piece of content information related to the search keyword is identified of the plurality of pieces of content information by performing the search process, the search server supplies the terminal apparatus with the single piece of content information.

According to any of the terminal apparatus and the image forming system according to one embodiment of the technology, the terminal apparatus generates the search instruction information including the search keyword on the basis of the apparatus information and the notification information both acquired by the terminal apparatus from the image forming apparatus. Further, the terminal apparatus accesses the search server with the use of the generated search instruction information. Hence, it is possible to increase user friendliness, vendor friendliness, or both.

Although the technology has been described in terms of exemplary embodiments, it is not limited thereto. It should be appreciated that variations may be made in the described embodiments by persons skilled in the art without departing from the scope of the invention as defined by the following claims. The limitations in the claims are to be interpreted broadly based on the language employed in the claims and not limited to examples described in this specification or during the prosecution of the application, and the examples are to be construed as non-exclusive. For example, in this disclosure, the term “preferably”, “preferred” or the like is non-exclusive and means “preferably”, but not limited to. The use of the terms first, second, etc. do not denote any order or importance, but rather the terms first, second, etc. are used to distinguish one element from another. The term “substantially” and its variations are defined as being largely but not necessarily wholly what is specified as understood by one of ordinary skill in the art. The term “about” or “approximately” as used herein can allow for a degree of variability in a value or range. Moreover, no element or component in this disclosure is intended to be dedicated to the public regardless of whether the element or component is explicitly recited in the following claims.

What is claimed is:

1. A terminal apparatus comprising:
an acquiring circuitry that acquires, from an image forming apparatus having a trouble, apparatus information related to the image forming apparatus and notification information corresponding to the trouble;
a generator that generates search instruction information on a basis of the apparatus information and the notification information both acquired by the acquiring circuitry, the search instruction information including a search keyword to be used in a search server;
a communicator that acquires a search result related to the trouble by accessing the search server with use of the search instruction information; and
a display that displays the search result.

2. The terminal apparatus according to claim 1, wherein the generator generates the search instruction information by executing application software.

3. The terminal apparatus according to claim 1, wherein the notification information comprises the search keyword to be used in the search server.

4. The terminal apparatus according to claim 1, wherein the generator converts the notification information into the search keyword and generates the search instruction information on a basis of the apparatus information and the search keyword.

5. The terminal apparatus according to claim 1, wherein
the communicator performs network communication between the communicator and the search server, and
the search instruction information comprises a uniform resource identifier.

6. The terminal apparatus according to claim 1, wherein the search result comprises information indicating a list of a result of searching performed by the search server.

7. The terminal apparatus according to claim 1, wherein the search result includes content information indicating a way to deal with the trouble.

8. The terminal apparatus according to claim 1, wherein
the apparatus information and the notification information are written on an integrated circuit tag of the image forming apparatus, and
the acquiring circuitry acquires the apparatus information and the notification information from the integrated circuit tag.

9. An image forming system comprising:
an image forming apparatus that forms an image on a print medium;
a search server that provides content information based on a search keyword by performing a search process; and
a terminal apparatus,
the terminal apparatus including
an acquiring circuitry that acquires from the image forming apparatus, when the image forming apparatus is having a trouble, apparatus information related to the image forming apparatus and notification information corresponding to the trouble,
a generator that generates search instruction information on a basis of the apparatus information and the notification information both acquired by the acquiring circuitry, the search instruction information including the search keyword,
a communicator that acquires a search result related to the trouble by accessing the search server with use of the search instruction information, and
a display that displays the search result.

10. The image forming system according to claim 9, wherein
the image forming apparatus includes an integrated circuit tag and an operation section that receives operation performed by a user,
the image forming apparatus writes the apparatus information and the notification information on the integrated circuit tag on a basis of an instruction given from the operation section when the trouble occurs, and
the acquiring circuitry of the terminal apparatus acquires the apparatus information and the notification information from the integrated circuit tag.

11. The image forming system according to claim 9, wherein
the search server includes a plurality of pieces of content information,
when two or more pieces of content information related to the search keyword are identified of the plurality of pieces of content information by performing the search process, the search server supplies the terminal apparatus with a list of the two or more pieces of content information, and
when a single piece of content information related to the search keyword is identified of the plurality of pieces of content information by performing the search process, the search server supplies the terminal apparatus with the single piece of content information.
